(19) United States
(12) Patent Application Publication
(10) Pub. No.: US 2013/0168539 A1
(43) Pub. Date: Jul. 4, 2013

(54) OPTICAL FIBER CONNECTOR

(71) Applicant: I-THUN LIN, Tu-Cheng (TW)

(72) Inventor: I-THUN LIN, Tu-Cheng (TW)

(73) Assignee: HON HAI PRECISION INDUSTRY CO., LTD., Tu-Cheng (TW)

(21) Appl. No.: 13/562,293

(22) Filed: Jul. 30, 2012

(30) Foreign Application Priority Data
Dec. 28, 2011 (TW) 100149253

(51) Int. Cl. G01J 1/42

(52) U.S. Cl. 250/227.11

(57) ABSTRACT

An optical fiber connector includes a photoelectric conversion module and two optical fibers. The photoelectric conversion module includes a PCB, a light emitting unit, and a light receiving unit. The light emitting unit and the light receiving unit are positioned on the PCB and apart from each other. The light emitting unit and the light receiving unit are electrically connected to the PCB. The optical fibers with distal portions thereof are aligned with and optically coupled with the light emitting unit and the light receiving unit. The longitudinal direction of the distal portions of the optical fibers is perpendicular to the PCB.

### BACKGROUND

1. Technical Field

The present disclosure relates to optical fiber connectors and, particularly, to an optical fiber connector which can be used as an optical receiving terminal or an optical emitting terminal.

2. Description of Related Art

The optical signals through optical fiber connectors need to be reflected by reflectors during optical signal transmission, and thus the number of reflecting interfaces is increased. Therefore, the transmission efficiency of the optical signals is reduced.

Therefore, it is desirable to provide an optical fiber connector, which can overcome or alleviate the above-mentioned problems.

### BRIEF DESCRIPTION OF THE DRAWINGS

FIG. 1 is a schematic, isometric view of an optical fiber connector, according to an exemplary embodiment.

FIG. 2 is an exploded view of the optical fiber connector of FIG. 1.

FIG. 3 is similar to FIG. 2, viewed from another aspect.

### DETAILED DESCRIPTION

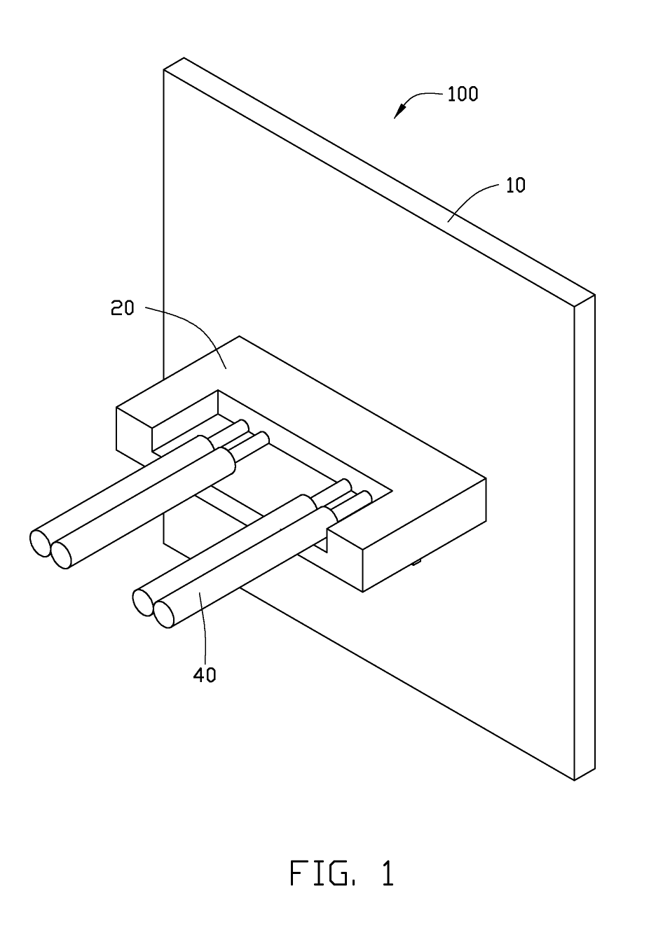

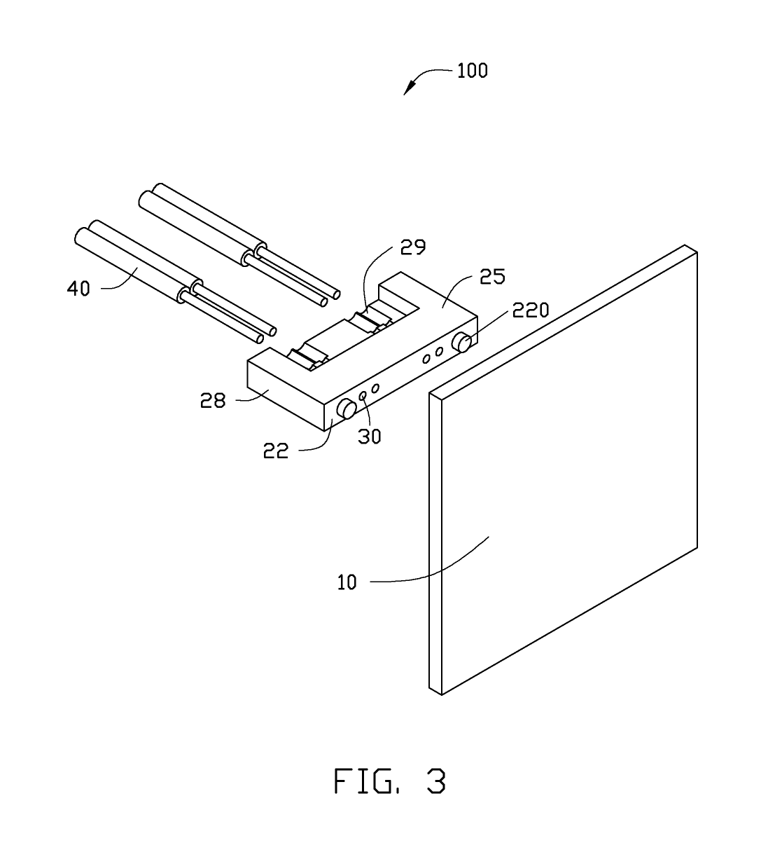

Referring to FIGS. 1 and 3, an optical fiber connector 100 includes a photoelectric conversion module 10, a connector body 20, four optical lenses 30, and four optical fibers 40.

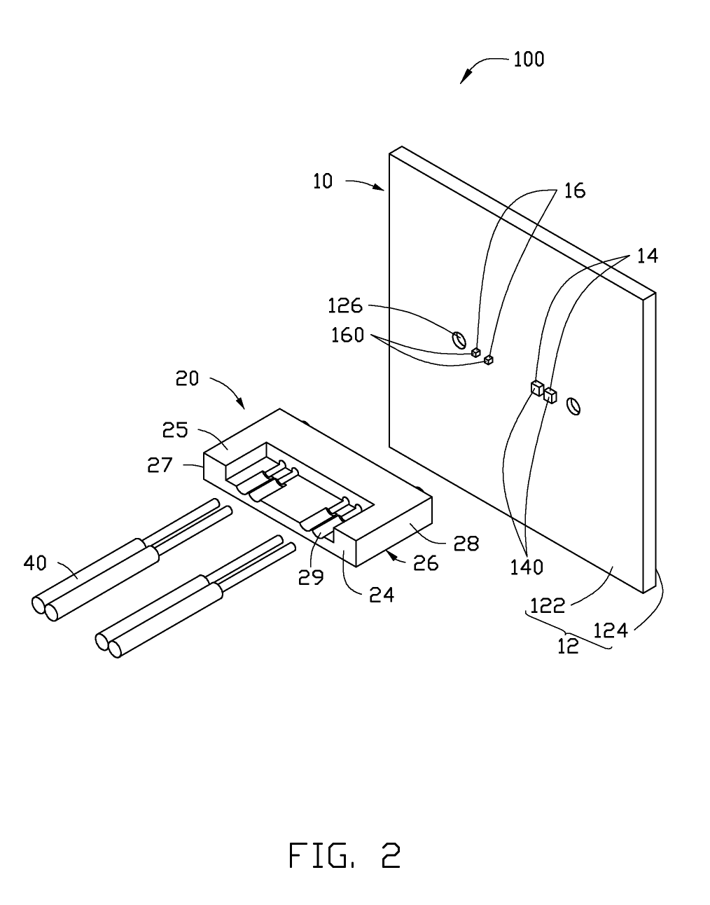

Referring to FIGS. 1 and 2, the photoelectric conversion module 10 includes a printed circuit board (PCB) 12, two light emitting units 14, and two light receiving units 16.

The PCB 12 includes a first surface 122 and a second surface 124. The first surface 122 is opposite to the second surface 124. The PCB 12 defines two engaging holes 126. Each engaging hole 126 passes through the first surface 122 but does not reach the second surface 124. In this embodiment, the engaging holes 126 are circular and blind.

The light emitting units 14, for example laser diodes, and the light receiving units 16, for example photodiodes, are positioned on the first surface 122 and apart from each other. The light emitting units 14 and the light receiving units 16 are arranged between the two engaging holes 126, and are electrically connected to the PCB 12 through wires (not shown). In this embodiment, the light emitting units 14, the light receiving units 16, and the engaging holes 126 are arranged in a line. Each light emitting unit 14 has a light emitting face 140, and the light emitting face 140 faces away from the first surface 122. Each light receiving unit 16 has a light receiving face 160, and the light receiving face 160 faces away from the first surface 122. In this embodiment, the light emitting faces 140 and the light receiving faces 160 are parallel to the first surface 122. The light emitting units 14 are vertical cavity surface emitting laser diodes (VCSEL) and are configured for emitting an optical signal. The light receiving units 16 are photo diodes and are configured for receiving an optical signal.

The connector body 20 is substantially a transparent cuboid. The connector body 20 includes a front surface 22, a back surface 24, an upper surface 25, a lower surface 26, a first side surface 27, and a second side surface 28. The front surface 22 is parallel to the back surface 24. The front surface 22 is adjacent to the first surface 122. The back surface 24 faces away from the first surface 122. The first side surface 27 is parallel to the second side surface 28. The front surface 22, the first side surface 27, the back surface 24, and the second side surface 28 are perpendicularly connected to each other end-to-end. The front surface 22, the first side surface 27, the back surface 24, and the second side surface 28 perpendicularly connect the upper surface 25 to the lower surface 26. Four blind holes 29 are defined in the connector body 20 and oriented along a direction perpendicular to the PCB 12. Two plugs 220 perpendicularly extend from the front surface 22 and correspond to the engaging holes 126.

The optical lenses 30 are formed on the front surface 22 and aligned with the blind holes 29. The optical lenses 30 and the plugs 220 are arranged in a line along the longitudinal direction of the front surface 22. The optical lenses 30 are located between the two plugs 220. Two optical lenses 30 are aligned with the two light emitting units 14, and the other two optical lenses 30 are aligned with the two light receiving units 16. In this embodiment, the optical lenses 30 and the connector body 20 are formed into a unitary piece.

The optical fibers 40 have distal portions, and the distal portions are received in the blind holes 29 so as to align and optically couple with the optical lenses 30. The longitudinal direction of distal portions of the optical fibers 40 is perpendicular to the PCB 12.

In assembly, the optical fibers 40 are inserted into the blind holes 29. The plugs 220 engage in the engaging holes 126 to connect the connector body 20 to the PCB 12. In this situation, the front surface 22 is parallel to the first surface 122. The longitudinal direction of the distal portions of the optical fibers 40 is perpendicular to the first surface 122. Two optical fibers 40 are aligned and optically coupled with the two optical lenses 30 and with the light emitting units 14, and the other two optical fibers 40 are aligned and optically coupled with the other optical lenses 30 and with the light receiving units 16.

In use, when the optical fiber connector 100 is used as an optical emitting terminal, optical signals emitted from the light emitting units 14 are converged by the optical lenses 30 and enter into the optical fibers 40, and then reach another optical fiber connector (not shown). When the optical fiber connector 100 is used as an optical receiving terminal, optical signals from another optical fiber connector (not shown) pass through the optical fibers 40 and are converged by the respective optical lenses 30, and then reach the light receiving units 16. During this process, the optical fiber connector 100 avoids using any reflectors, and thus the number of reflecting interfaces is reduced. Therefore, the transmission efficiency and reliability of the optical signal is improved.

In another embodiment, the optical lenses 30 can be omitted, and four through holes can be substituted instead of the four blind holes 29. The optical fibers 40 are inserted into the through holes and directly align with the light emitting units 14 or the light receiving units 16. In this situation, when the optical fiber connector 100 is used as an optical emitting terminal, optical signals emitted from the light emitting units 14 directly enter into the optical fibers 40 and then reach another optical fiber connector (not shown). When the optical fiber connector 100 is used as an optical receiving terminal, optical signals from another optical fiber connector (not shown) pass through the optical fibers 40 and then directly reach the light receiving units 16. During this process, the optical fiber connector 100 avoids using any reflectors and the optical lenses, and thus the number of reflecting interfaces is further reduced. Therefore, the transmission efficiency of the optical signal is further improved.

Even though numerous characteristics and advantages of the present embodiments have been set fourth in the foregoing description, together with details of the structures and functions of the embodiments, the disclosure is illustrative only, and changes may be made in details, especially in the matters of shape, size, and the arrangement of parts within the principles of the disclosure to the full extent indicated by the broad general meaning of the terms in which the appended claims are expressed.

What is claimed is:

1. An optical fiber connector comprising:
a photoelectric conversion module comprising:
a printed circuit board (PCB);
a light emitting unit and a light receiving unit, the light emitting unit and the light receiving unit positioned on the PCB and apart from each other, the light emitting unit and the light receiving unit electrically connected to the PCB; and
two optical fibers with distal portions thereof aligned with and optically coupled with the light emitting unit and the light receiving unit, the longitudinal direction of the distal portions of the optical fibers being perpendicular to the PCB.

2. The optical fiber connector as claimed in claim 1, wherein the PCB comprises a first surface and a second surface opposite to the first surface, the light emitting unit and the light receiving unit are positioned on the first surface, the light emitting unit having a light emitting face and the light receiving unit having a light receiving face, the light emitting face and the light receiving face face away from the first surface, and the longitudinal direction of the distal portions of optical fibers is perpendicular to the first surface.

3. The optical fiber connector as claimed in claim 2, wherein the light emitting face and the light receiving face are parallel to the first surface.

4. The optical fiber connector as claimed in claim 2, further comprising a connector body, wherein the connector body comprises a front surface, a back surface opposite to the front surface, the front surface and the back surface are parallel to the first surface, the front surface is adjacent to the first surface, the back surface faces away from the first surface, two through holes are defined in the connector body and oriented along a direction perpendicular to the PCB, and the distal portions of the optical fibers are received in the respective through holes.

5. The optical fiber connector as claimed in claim 4, wherein two engaging holes are defined in the first surface, two plugs extend from the front surface, and the plugs are engaged in the respective engaging holes.

6. An optical fiber connector comprising:
a photoelectric conversion module comprising:
a printed circuit board (PCB);
a light emitting unit and a light receiving unit, the light emitting unit and the light receiving unit positioned on the PCB and apart from each other, the light emitting unit and the light receiving unit electrically connected to the PCB;
two optical fibers having distal portions aligned with and optically coupled with the light emitting unit and the light receiving unit, the longitudinal direction of the distal portions of the optical fibers being perpendicular to the PCB; and
two optical lenses arranged between the optical fibers and the photoelectric conversion module, the optical lenses configured for optically coupling the optical fibers with the light emitting unit and the light receiving unit.

7. The optical fiber connector as claimed in claim 6, wherein the PCB comprises a first surface and a second surface opposite to the first surface, the light emitting unit and the light receiving unit are positioned on the first surface, the light emitting unit having a light emitting face and the light receiving unit having a light emitting face, the light emitting face and the light receiving face face away from the first surface, and the longitudinal direction of the distal portions of the optical fibers is perpendicular to the first surface.

8. The optical fiber connector as claimed in claim 7, wherein the light emitting face and the light receiving face are parallel to the first surface.

9. The optical fiber connector as claimed in claim 7, further comprising a connector body, wherein the connector body comprises a front surface, a back surface opposite to the front surface, the front surface and the back surface are parallel to the first surface, the front surface is adjacent to the first surface, the back surface faces away from the first surface, two blind holes are defined in the connector body and oriented along a direction perpendicular to the PCB, the distal portions of the optical fibers are received in the respective blind holes, and the optical lenses are formed on the front surface.

10. The optical fiber connector as claimed in claim 9, wherein two engaging holes are defined in the first surface, two plugs extend from the front surface, and the plugs are engaged in the respective engaging holes.
